(19) United States
(12) Patent Application Publication
(10) Pub. No.: US 2010/0105395 A1
(43) Pub. Date: Apr. 29, 2010

(54) Method for the cell ID selection for femtocell basestation

(75) Inventors: Baowei Ji, Plano, TX (US); William J. Semper, Richardson, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/380,149

(22) Filed: Feb. 24, 2009

Related U.S. Application Data
(60) Provisional application No. 61/197,590, filed on Oct. 28, 2008.

(51) Int. Cl. H04W 36/00

(52) U.S. Cl. 455/444; 455/436

(57) ABSTRACT

A method for selecting a Cell ID for a base station is provided. The base station may be a Femto base station. The method includes obtaining a neighbor Cell ID corresponding to at least one of a plurality of neighboring base stations. The method also includes selecting a new Cell ID, where the new Cell ID is different than the neighbor Cell ID. The method further includes broadcasting a message containing the new Cell ID. Further, the method includes assigning the new Cell ID to the base station.

### CROSS-REFERENCE TO RELATED APPLICATION(S) AND CLAIM OF PRIORITY

The present application is related to U.S. Provisional Patent No. 61/197,590, filed Oct. 28, 2008, entitled “METHOD FOR THE CELL ID SELECTION FOR FEMTOCELL BASESTATION”. Provisional Patent No. 61/197,590 is assigned to the assignee of the present application and is hereby incorporated by reference into the present application as if fully set forth herein. The present application hereby claims priority under 35 U.S.C. §119(e) to U.S. Provisional Patent No. 61/197,590.

### TECHNICAL FIELD OF THE INVENTION

The present application relates generally to wireless communication systems and, more specifically, to a method for selecting a cell ID for a base station.

### BACKGROUND OF THE INVENTION

In a cellular network, such as one utilizing orthogonal frequency division multiple access (OFDMA), each cell employs a base station that communicates with one or more mobile stations that are located within the cell. When each mobile station is first turned on, it must perform an initial cell search in order to be connected to the cellular network. This involves a downlink synchronization process between the base station and the mobile station wherein the base station sends a synchronization signal to the mobile station. The synchronization signal is also referred to as a synchronization preamble, a synchronization channel, or simply, a cell ID. The signal could include just one synchronization channel, or one primary synchronization channel plus one secondary synchronization channel, or one long preamble plus one or more short preambles. Each base station in a local area must have its own unique preambles or Cell ID's. If more than one base station in a neighborhood uses the same Cell ID, a signal collision could occur.

The base stations implemented in a cellular network can vary in capability and function. A relatively new type of base station is the Femtocell Gateway. (FGTW), also referred to as a Femto base station. Femtocell devices are small base stations designed for home or small business use. Femto base stations operate in a small (<200 m) range and are designed to provide cellular coverage in the home or office. The typical Femto base station connects to a Security Gateway or Softswitch over an Internet Protocol (IP) connection, such as a DSL or broadband cable connection. The Security Gateway or Softswitch is intended to plug into the DSL or cable modem using a standard Ethernet cable.

Connecting a Femto Access Point (FAP) to an operator's network is the subject of standardization in various standards bodies. For instance, IEEE 802.16m addresses standards for various advanced wireless interfaces relating to macro and micro cellular coverage.

A Femto base station transmits in low power. Femto base stations typically are installed by a subscriber in a home or small office environment to provide access to a closed or open group of users as configured by the subscriber and/or the access provider. A Femto base station typically operates in a licensed spectrum and may use the same or different frequency as macro cells. Additionally, a Femto base station may use a broadband connection such as cable or DSL for backhaul. The mobile stations accessing a Femto cell typically are stationary or moving at low (i.e., pedestrian) speed. Femto cells could share a significant amount of the traffic burden in a macro cell.

### SUMMARY OF THE INVENTION

A method for selecting a Cell ID for a base station is provided. The method includes obtaining a neighbor Cell ID corresponding to at least one of a plurality of neighboring base stations. The method also includes selecting a new Cell ID, where the new Cell ID is different than the neighbor Cell ID. The method further includes broadcasting a message containing the new Cell ID. Further, the method includes assigning the new Cell ID to the base station.

A base station for use in a wireless communication network is provided. The base station includes a controller. The controller is configured to obtain a neighbor Cell ID corresponding to at least one of a plurality of neighboring base stations. The controller is also configured to select a new Cell ID, where the new Cell ID is different than the neighbor Cell ID. Further, the controller is configured to broadcast a message containing the new Cell ID. The controller is also configured to assign the new Cell ID to the base station.

A wireless network comprising a plurality of base stations is provided. Each base station includes a controller. The controller is configured to obtain a neighbor Cell ID corresponding to at least one of a plurality of neighboring base stations. The controller is also configured to select a new Cell ID, where the new Cell ID is different than the neighbor Cell ID. Further, the controller is configured to broadcast a message containing the new Cell ID. The controller is also configured to assign the new Cell ID to the base station.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an Orthogonal Frequency Division Multiple Access (OFDMA) wireless network according to embodiments of the present disclosure;

FIG. 1B illustrates a Self-Organizing Network according to embodiments of the present disclosure;

FIG. 2 illustrates an exemplary data packet in an OFDMA network according to embodiments of the present disclosure;

FIG. 3 is a flow diagram illustrating a process for initially selecting a Cell ID in a cell initialization stage according to embodiments of the present disclosure; and

FIG. 4 is a flow diagram illustrating a process for dynamically detecting a Cell ID collision and selecting a new Cell ID to resolve the collision according to embodiments of the present disclosure.

### DETAILED DESCRIPTION OF THE INVENTION

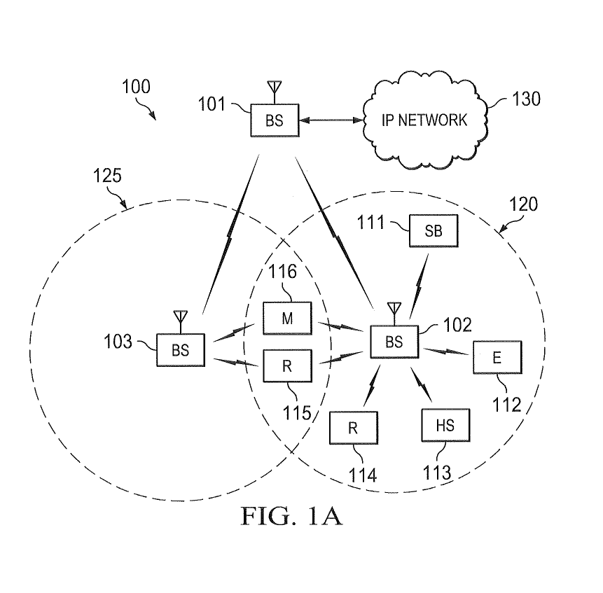

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

With regard to the following description, it is noted that the 3GPP Long Term Evolution (LTE) term “node B” is another term for “base station” used below. Also, the terms “user equipment”, “subscriber station”, and “mobile station” all refer to the same category of equipment, and are used interchangeably below.

FIG. 1A illustrates an exemplary Orthogonal Frequency Division Multiple Access (OFDMA) wireless network 100 according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary. IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Each subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, cafe, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area.

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

FIG. 1B illustrates a Self-Organizing Network (SON) according to embodiments of the present disclosure. The embodiment of the SON 140 shown in FIG. 1B is for illustration only. Other embodiments of the SON 140 could be used without departing from the scope of this disclosure.

SON 140 includes BS 101, BS 102 and BS 103. Each of BS 101, BS 102 and BS 103 communicate with each other as described above with respect to FIG. 1A. Further, each of BS 102 and BS 103 communicates with their respective subscriber stations 111-116 as described above with respect to FIG. 1A. SON 140 further includes FGTW 150. FGTW 150 is a newly installed Femto base station. It will be understood that illustration of FGTW 150 as a Femto base station is by way of example only. Embodiments wherein FGTW 150 is a node B (e.g., macro base station such as BS 101-BS 103) could be used without departing from the scope of this disclosure.

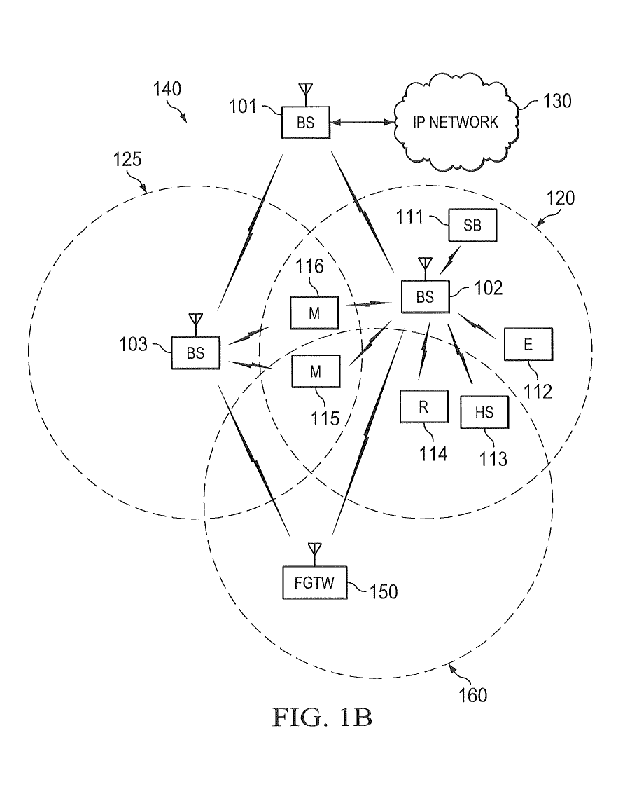

FIG. 2 illustrates an exemplary data packet 200 in an OFDMA network according to embodiments of the present disclosure. The embodiment of the data packet 200 shown in FIG. 2 is for illustration only. Other embodiments of the data packet 200 could be used without departing from the scope of this disclosure.

In a wireless network, each base station, such as BS 101, BS 102, BS 103 and FGTW 150, is associated with a preamble or cell ID. The Cell ID is included in every data packet that is communicated to or from the base station. FIG. 2 illustrates a data packet 200 in an OFDMA network. Packet 200 includes a portion 205 coded as a Cell ID. Packet 200 also includes a data portion 210. In some embodiments, data portion 210 may include additional header or identification information.

In some embodiments, BS 101, BS 102 and BS 103 are each assigned a Cell ID by the network operator. In such embodiments, BS 101, BS 102 and BS 103 are dependent upon the network operator for management of Cell IDs, and to ensure that signal collisions do not occur. As the number of base stations in a network increases (e.g., more base stations added to the network), assignment of Cell IDs becomes an increasing burden for the network operator.

In some embodiments, BS 101, BS 102 and BS 103 are each capable of selecting and broadcasting their own Cell ID without intervention by the network operator. A network wherein each base station, such as BS 101, BS 102 and BS 103, is capable of selecting and broadcasting their own Cell IDs is referred to as a self-organizing network. Self-organization is particularly useful in larger networks, such as those containing a large number of homes or small offices with Femto base stations. Self-organization can also be beneficial in networks with mobile base stations, such as those in military applications.

In SON 140, BS 102, BS 103 and BS 101 each select their own Cell ID. Due to the limited number of Cell IDs available under IEEE standards, it is possible that two neighboring base stations, such as BS 102 and BS 103, could select the same Cell ID. Accordingly, before and after FGTW 150 selects a Cell ID, FGTW 150 must be aware of the existence of BS 102 and BS 103 (e.g., neighboring base stations) to ensure that signal collisions do not occur. FTGW 150, BS 102 and BS 103 must regularly check for collisions, because a new neighboring base station could come online or change its Cell ID at any time. FGTW 150, BS 101, BS 102 and BS 103 in SON 140 can be of various types including, but not limited to, Femto base stations, macro base stations, micro base stations, pico base stations, relay stations (RS) and mobile base stations that are capable of self-organizing.

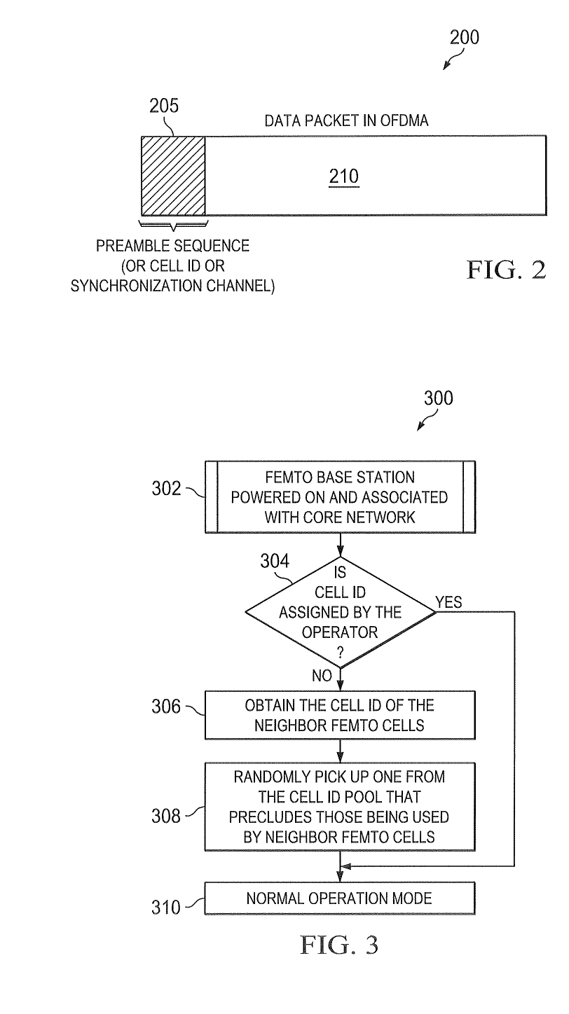

FIG. 3 illustrates a process for initially selecting a Cell ID during a cell initialization stage according to one embodiment of the present disclosure. The embodiment of the selecting process 300 shown in FIG. 3 is for illustration only. Other embodiments of the selecting process 300 could be used without departing from the scope of this disclosure.

In Step 302, Femto base station 150 is powered on and associated with the core network. In some embodiments, FGTW 150 is one of multiple base stations in SON 140. Some of the base stations, such as BS 102 and BS 103 in SON 140 neighbor FGTW 150. Other base stations, such as BS 101, are distant from FGTW 150.

Once FGTW 150 is powered on, a Cell ID may or may not be assigned to the base station by the operator of the core network, as shown in Step 304. If a Cell ID is assigned by the network operator to FGTW 150 at the time of power on, then FGTW 150 uses the Cell ID that has been assigned. At that point, the process moves directly to normal operation mode, as shown in Step 310.

If a Cell ID is not assigned by the network operator at the time of power on, then the process moves to Step 306. In Step 306, FGTW 150 determines what Cell IDs currently are being used by neighboring base stations. In one exemplary embodiment, FGTW 150 scans the environment to detect signals from BS 102 and BS 103 (e.g., the neighboring base stations). Once FTGW 150 detects a signal from a neighboring base station, the Femto base station determines what Cell ID is being used by that neighbor.

In another exemplary embodiment, SS 114, in contact with neighboring base station, informs the FTGW 150 of the Cell IDS of the neighboring base stations. Obtaining the Cell ID of a neighboring base station from stations 114 can be useful when the signal from BS 102 is too weak to be interpreted at FTGW 150. In additional embodiments, SS 114 can report to the FTGW 150 at a predetermined time interval, or only when the stations 114 detect a potential signal collision, or only when the FTGW 150 requests a report from the mobile station.

The determination of neighboring Cell IDs is repeated for as many neighbors as can be detected.

In Step 308, the FTGW 150 chooses a Cell ID for use in the core network. In some embodiments, FTGW 150 randomly chooses a Cell ID. FTGW 150 then compares the chosen Cell ID against the list of neighboring Cell IDs, as determined in Step 306. If the randomly chosen Cell ID is the same as any of the neighboring Cell IDs, then the randomly chosen Cell ID cannot be used. In such a case, FTGW 150 randomly chooses another Cell ID. The process is repeated until FTGW 150 chooses a Cell ID that is not the same as any neighboring Cell ID. In some embodiments, FTGW 150 chooses a Cell ID in a pseudo-random way. Namely, the selection of a Cell ID could consider the factors such as the location of the FTGW, the timestamp, etc.

Once a unique Cell ID is found, FTGW 150 starts to use the selected Cell ID. Before the switch to the selected Cell ID occurs, FTGW 150 broadcasts a message containing the Cell ID to the mobile stations in the cell. Since FTGW 150 may be serving a number of mobile stations, it is necessary that the mobile stations be informed of the new Cell ID. The broadcast message informs SS 113 and SS 114 of the new Cell ID. Mobile stations SS 113 and SS 114 then assume the new Cell ID of FTGW 150.

The process then moves to normal operation mode, which is shown in Step 310. In some embodiments, FTGW 150 maintains its current Cell ID in normal operation mode as long as FTGW 150 is associated with the network 100. In other embodiments, FTGW 150 selects a new Cell ID during normal operation mode, as described below.

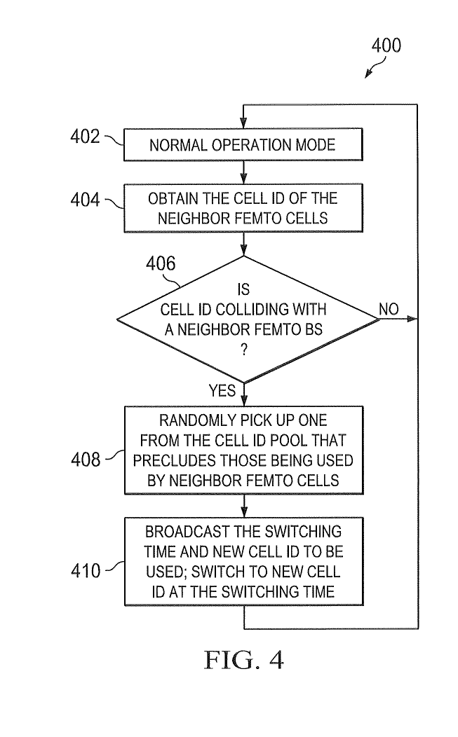

FIG. 4 illustrates a process for dynamically detecting a Cell ID collision and selecting a new Cell ID to resolve the collision, according to one embodiment of the present disclosure. The embodiment of the selecting process 400 shown in FIG. 4 is for illustration only. Other embodiments of the selecting process 400 could be used without departing from the scope of the disclosure.

In Step 402, FTGW 150 and its neighboring base stations, BS 102 and BS 103, are operating in normal operation mode. If the Cell ID was not assigned to each base station by the core network during power on, then it is possible that BS 102 and BS 103 could, at some point, have the same Cell ID. Therefore, during normal operation mode, FTGW 150, BS 102 and BS 103 periodically evaluate whether any neighboring base stations are using the same Cell ID.

In Step 404, FTGW 150 obtains the Cell ID of neighboring base stations BS 102 and BS 103. In one exemplary embodiment, FTGW 150 attempts to detect signals from BS 102 and BS 103. Once FTGW 150 detects a signal from BS 102, BS 103 or both, FTGW 150 determines what Cell ID is being used by that neighbor. In yet another embodiment, FTGW 150 requests mobile stations in the cell, such as SS 113 and SS 114, to measure and report the Cell ID being used by neighboring base stations, such as BS 102 and BS 103. This determination of neighboring Cell IDs is repeated for as many neighbors as can be detected.

In Step 406, FTGW 150 compares its current Cell ID against the list of neighboring Cell IDs, as determined in Step 404. If FTGW 150 finds that BS 102 and BS 103 are not using the same Cell ID (e.g, no neighboring base station is using the same Cell ID), then the process returns back to normal operation mode in Step 402. However, if FTGW 150 finds that one of BS 102 and BS 103 is using the same Cell ID, then FTGW 150 chooses a new Cell ID, as shown in Step 408.

In Step 408, FTGW 150 randomly chooses a new Cell ID. FTGW 150 then compares the chosen Cell ID against the list of neighboring Cell IDs, as determined in Step 404. If the randomly chosen Cell ID is the same as any of the neighboring Cell IDs, then the randomly chosen Cell ID cannot be used. In such a case, FTGW 150 randomly chooses another Cell ID. The process is repeated until FTGW 150 chooses a Cell ID that is not the same as any neighboring Cell ID.

Once a unique Cell ID is found, the process moves to Step 410. In Step 410, FTGW 150 broadcasts a message including the new Cell ID and the incoming switching time to SS 113 and SS 114 (e.g., FTGW 150's served mobile stations). This message ensures that SS 113 and SS 114 can be continuously served by FTGW 150 after the switching time using the new Cell ID. FTGW 150 may also inform the core network 100 of the new Cell ID after successfully switching to the new ID.

In some embodiments, it is possible that two neighboring base stations (e.g., BS 102 and FTGW 150) that are using the same Cell ID will both initiate the process to change their Cell ID at approximately the same time. When this occurs, BS 102 may broadcast a message of its new Cell ID before FTGW 150 actually selects its new Cell ID. If FTGW 150 receives the broadcast message that BS 102 has already selected a new Cell ID, then the collision is resolved without FTGW 150 needing to select a new Cell ID. In such a circumstance, FTGW 150 can cancel the reselection process by broadcasting a message of the cancellation to the associated mobile stations.

Once FTGW 150 has a Cell ID that is unique compared to BS 102 and BS 103, then FTGW 150 returns to normal operation mode, as shown in Step 402.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communication network, a method of selecting a Cell ID for a base station, the method comprising:
obtaining a neighbor Cell ID corresponding to at least one of a plurality of neighboring base stations;
selecting a new Cell ID, the new Cell ID different than the neighbor Cell ID;
broadcasting a message containing the new Cell ID; and
assigning the new Cell ID to the base station.

2. The method as set forth in claim 1, wherein the step of selecting further comprises:
identifying a prospective Cell ID from a list of Cell IDs;
determining if the prospective Cell ID is the same as the neighbor cell ID; and
choosing the prospective Cell ID as the new Cell ID.

3. The method as set forth in claim 1, wherein obtaining the neighbor Cell ID comprises detecting, at the base station, signals from the at least one neighboring base station.

4. The method as set forth in claim 1, wherein obtaining the neighbor Cell ID comprises receiving the neighbor Cell ID from a mobile station that is in contact with the at least one neighboring base station.

5. The method as set forth in claim 1, wherein the base station is one of a Femto base station, a macro base station, a micro base station, a pico base station, and a relay station.

6. The method as set forth in claim 1, the method further comprising the step of:
at one of the plurality of neighboring base stations, canceling a process of selecting a new neighbor Cell ID upon receiving the broadcast message containing the new Cell ID assigned to the base station.

7. The method as set forth in claim 1, wherein selecting a new Cell ID for the base station comprises randomly choosing the new Cell ID for the base station.

8. For use in a wireless communication network, a base station comprising:
a controller, the controller configured to:
obtain a neighbor Cell ID corresponding to at least one of a plurality of neighboring base stations;
select a new Cell ID, the new Cell ID different than the neighbor Cell ID;
broadcast a message containing the new Cell ID; and
assign the new Cell ID to the base station.

9. The base station as set forth in claim 8, wherein the controller is further configured to:
identify a prospective Cell ID from a list of Cell IDs;
determine if the prospective Cell ID is the same as the neighbor cell ID; and
choose the prospective Cell ID as the new Cell ID.

10. The base station as set forth in claim 8, wherein obtaining the neighbor Cell ID comprises detecting, at the base station, signals from the least one neighboring-base station.

11. The base station as set forth in claim 8, wherein obtaining the neighbor Cell ID comprises receiving the neighbor Cell ID from a mobile station that is in contact with the at least one neighboring base station.

12. The base station as set forth in claim 8, wherein the base station is one of a Femto base station, a macro base station, a micro base station, a pico base station, and a relay station.

13. The base station as set forth in claim 8, wherein one of the plurality of neighboring base stations cancels a process of selecting a new neighbor Cell ID upon receiving the broadcast message containing the new Cell ID assigned to the base station.

14. The base station as set forth in claim 8, wherein selecting a new Cell ID for the base station comprises randomly choosing the Cell ID for the base station.

15. A wireless network comprising a plurality of base stations, each base station comprising:
a controller, the controller configured to:
obtain a neighbor Cell ID corresponding to at least one of a plurality of neighboring base stations;
select a new Cell ID, the new Cell ID different than the neighbor Cell ID;
broadcast a message containing the new Cell ID; and
assign the new Cell ID to the base station.

16. The wireless network as set forth in claim 15, wherein the controller of each base station is further configured to:
identify a prospective Cell ID from a list of Cell IDs;
determine if the prospective Cell ID is the same as the neighbor cell ID; and
choose the prospective Cell ID as the new Cell ID.

17. The wireless network as set forth in claim 15, wherein obtaining the neighbor Cell ID comprises detecting, at the base station, signals from the least one neighboring base station.

18. The wireless network as set forth in claim 15, wherein obtaining the neighbor Cell ID comprises receiving the neighbor Cell ID from a mobile station that is in contact with the at least one neighboring base station.

19. The wireless network as set forth in claim 15, wherein at least one of the plurality of base stations is one of a Femto base station, a macro base station, a micro base station, a pico base station, and a relay station.

20. The wireless network as set forth in claim 15, wherein a first base station of the plurality of base stations cancels a process of selecting a new Cell ID upon receiving a broadcast message containing a new Cell ID assigned to a second base station of the plurality of base stations.

21. For use in a wireless communication network, a mobile station comprising:
a controller, the controller configured to:
obtain a Cell ID of each of a plurality of neighboring base stations; and
report the Cell ID of each of the plurality of neighboring base stations to a base station that serves the mobile station.

22. The mobile station as set forth in claim 21, wherein the controller is further configured to report the Cell ID of each of the plurality of neighboring base stations to the base station that serves the mobile station upon a request from the base station that serves the mobile station.

23. The mobile station as set forth in claim 21, wherein the controller is further configured to report the Cell ID of each of the plurality of neighboring base stations to the base station that serves the mobile station at a predetermined time interval.

24. The mobile station as set forth in claim 21, wherein the controller is further configured to report the Cell ID of each of the plurality of neighboring base stations to the base station that serves the mobile station when the controller detects a potential Cell ID collision.
